(19) United States
(12) Patent Application Publication
(10) Pub. No.: US 2026/0356255 A1
(43) Pub. Date: Nov. 12, 2026

(54) CHILD SAFETY SEAT

(71) Applicant: NINGBO YUANYUAN AUTO ACCESSORIES CO., LTD, Cixi City (CN)

(72) Inventor: Xijiong FU, Cixi City (CN)

(21) Appl. No.: 19/323,008

(22) Filed: Sep. 9, 2025

(30) Foreign Application Priority Data
May 12, 2025 (CN) CN202520937030.9

(51) Int. Cl. B60N 2/28

(52) U.S. Cl. CPC B60N 2/2821

(57) ABSTRACT

A child safety seat comprises a base and a seat assembly. The base includes a support portion and a backrest. Its innovation lies in an L-shaped metal reinforcement tube embedded within the base. The L-shaped reinforcement tube comprises a horizontal extension section and a vertical extension section. The horizontal extension section extends along the support portion, while the vertical extension section extends toward the backrest. The extension angle is adapted to the connection structure between the support portion and the backrest. Furthermore, the support portion and the backrest are provided with mounting slots for the L-shaped reinforcement tube. A connecting plate is provided behind the backrest, and the L-shaped reinforcement tube is secured via mechanical connectors. The L-shaped reinforcement tube has a closed loop cross-section.

### TECHNICAL FIELD

This utility model relates to the fields of automotive components and safety technology, and specifically to a child safety seat.

### BACKGROUND

In modern society, with the widespread adoption of automobiles, child safety in vehicles has become a critical issue of concern.

Child safety seats, as key equipment for ensuring child safety in vehicles, have a direct impact on children's lives through their performance and quality. Currently, injection molding is widely used in the manufacturing of child safety seats due to its ability to rapidly and mass-produce complex components.

However, the materials used in injection molding have significant limitations, particularly insufficient strength. In actual use, child safety seats must withstand a variety of external forces, such as vehicle bumps, inertial forces generated during acceleration and deceleration, and impact forces in extreme situations such as collisions. Due to the inherent strength limitations of injection molding materials, existing injection-molded child safety seats are prone to deformation or even damage during long-term use or when subjected to significant external forces.

This insufficient strength severely impacts the safety and reliability of child safety seats, preventing them from providing stable and reliable protection for children.

In previous child safety seats, such as application number 202510261895.2, the patent application failed to fully consider the critical issue of insufficient injection molded material strength during the base design. This resulted in a lack of effective reinforcement against various external forces, resulting in poor structural stability. When the vehicle encounters an emergency, the existing seat structure may not effectively distribute and withstand external forces, posing a safety hazard to consumers.

In summary, existing child safety seats suffer significant strength deficiencies, necessitating the development of a novel seat strength-enhancing structure to compensate for the insufficient strength of injection molded materials, enhance the seat's overall stability, and ensure reliable protection for children in various challenging environments.

### UTILITY MODEL SUMMARY

The technical problem addressed by this utility model is to address the aforementioned existing state of the art by providing a child safety seat that, through the provision of a strength-enhancing structure, effectively addresses the insufficient strength of existing injection molded child safety seats, thereby enhancing overall seat stability and improving child safety.

The present invention solves the above-mentioned technical problems by adopting a technical solution: a child safety seat comprising a base and a seat assembly mounted on the base. The base comprises a support portion and a backrest. A metal L-shaped reinforcement tube is embedded within the base. The L-shaped reinforcement tube comprises a horizontal extension section and a vertical extension section.

The horizontal extension section extends along the support portion, and the vertical extension section extends from the end of the horizontal extension section toward the backrest. The extension direction of the vertical extension section matches the connection structure between the support portion and the backrest, thereby enhancing the structural strength and impact resistance of the base.

To further optimize the fit between the vertical extension section and the backrest and enable the L-shaped reinforcement tube to better enhance structural strength, the vertical extension section is preferably arranged at an angle, and the angle of the vertical extension section matches the angle of the backrest, ensuring effective support at all stress points.

To facilitate installation of the L-shaped reinforcement tube and enhance its tightness and stability with the base, the support portion and backrest are preferably each provided with a mounting slot. The horizontal extension of the L-shaped reinforcement tube is nested within the support portion's mounting slot, while the vertical extension is nested within the backrest's mounting slot, effectively integrating the L-shaped reinforcement tube with the base.

To avoid stress concentration at the junction of the L-shaped reinforcement tube and the base's mounting slot, and to enhance the durability of the overall structure, the junction of the horizontal and vertical extensions is preferably an arc-shaped transition structure. The mounting slot at the junction of the support portion and backrest is also a smoothly transitioning arc-shaped structure, with the curvature radii of the two arcs matching to distribute stress and extend service life.

To ensure the L-shaped reinforcement tube is securely fixed to the backrest and prevents loosening during use, the L-shaped reinforcement tube is preferably secured to the backrest via mechanical fasteners. The mechanical fasteners are selected from at least one of bolts, screws, or rivets, providing a reliable connection.

To further strengthen the attachment of the L-shaped reinforcement tube to the backrest, creating a more stable connection, a connecting plate is preferably provided at the rear of the backrest. The mechanical connector passes through the connecting plate and the backrest in sequence from back to front, then securely connects to the L-shaped reinforcement tube, forming a three-point reinforcement structure to enhance overall stability.

To ensure the strength of the L-shaped reinforcement tube while optimizing its material efficiency and structural performance, the L-shaped reinforcement tube preferably has a closed loop cross-section. Its cross-sectional shape can be circular, elliptical, rectangular, or rounded-rectangular.

The appropriate cross-sectional shape can be selected based on specific requirements to enhance structural strength and impact resistance. To further enhance the overall strength and impact resistance of the base and ensure more uniform force distribution, at least two L-shaped reinforcement tubes are preferably provided, spaced parallel to each other along the width of the base, enhancing the base's support and impact resistance from multiple locations.

To ensure smooth and stable installation of the seat assembly and prevent the L-shaped reinforcement tube from interfering with its installation, the base's support portion preferably forms a top-opening mounting cavity for the seat assembly.

The mounting groove is formed at the bottom of the mounting cavity. After installation, the top surface of the L-shaped reinforcement tube is flush with or recessed below the bottom surface of the mounting cavity, ensuring a secure fit.

Compared to existing technologies, the present invention offers advantages in that a metal L-shaped reinforcement tube is embedded within the base, with a horizontal extension extending along the base support portion and a vertical extension extending from the end of the horizontal extension toward the backrest of the base.

The extension direction aligns with the connection structure between the support portion and the backrest. Because the L-shaped reinforcement tube is made of metal, it possesses inherent strength. The strategic layout of the horizontal and vertical extensions effectively distributes and withstands external forces, significantly enhancing the structural strength of the base.

During vehicle travel, whether encountering bumps, inertial forces from acceleration and deceleration, or impact forces from collisions, the L-shaped reinforcement tube is effective, reducing the possibility of deformation or even damage to the seat due to insufficient injection molding material strength, improving the seat's impact resistance and providing more reliable safety protection for children.

This solves the existing problem of poor seat safety and reliability due to insufficient injection molding material strength, while also avoiding the risk of injury to children caused by structural instability. It also eliminates the need for major changes to existing production processes, reducing production costs and enhancing the product's market competitiveness.

### BRIEF DESCRIPTION OF THE DRAWINGS

FIG. 1 is a schematic diagram of the three-dimensional structure of this embodiment;

FIG. 2 is a schematic diagram of the mating structure of the base and L-shaped reinforcement tube in this embodiment;

FIG. 3 is a schematic diagram of the reverse side of FIG. 2;

FIG. 4 is a schematic diagram of the exploded structure of the base, L-shaped reinforcement tube, and connecting plate in this embodiment.

### SPECIFIC IMPLEMENTATION METHODS

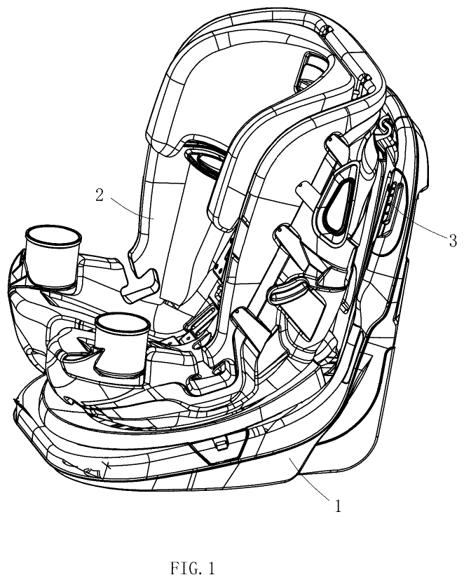

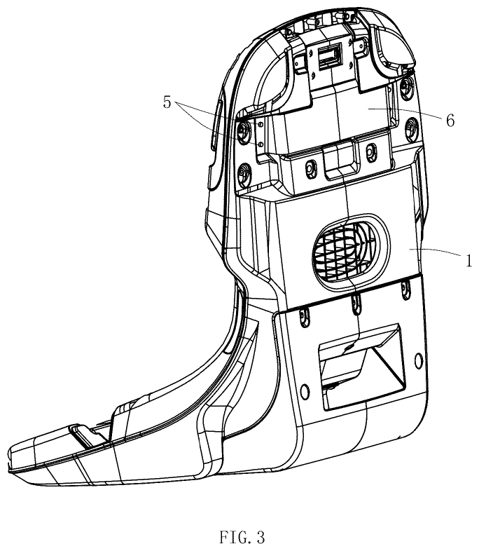

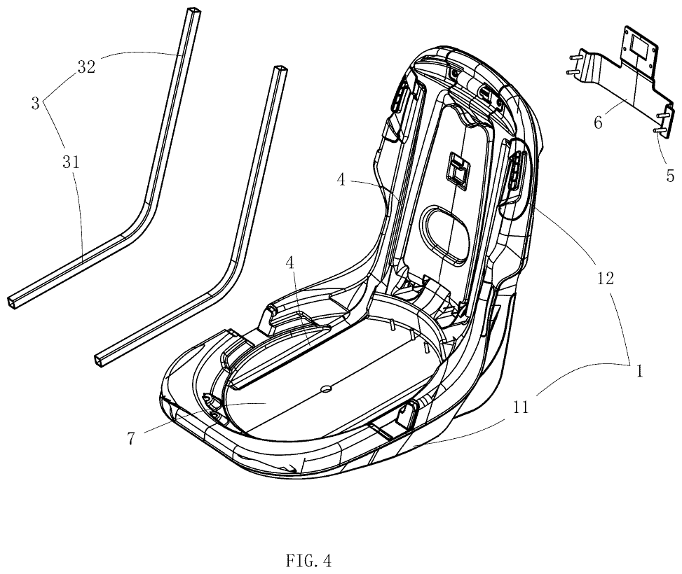

The following describes the present invention in further detail with reference to the accompanying drawings and embodiments. FIGS. 1 to 4 are schematic diagrams of this embodiment.

The child safety seat in this embodiment includes a base 1, a seat assembly 2, an L-shaped reinforcement tube 3, a mounting slot 4, a mechanical connector 5, a connecting plate 6, and other components. These components are described in detail below with reference to the accompanying figures.

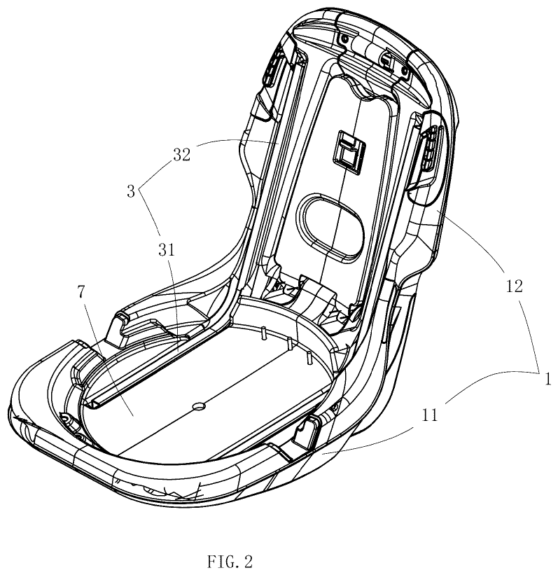

Base and Seat Assembly: Referring to FIGS. 1 and 2, the base 1 includes a support portion 11 and a backrest 12. The support portion 11 and backrest 12 form a stable frame structure, providing a stable support base for the seat assembly 2. The support portion 11 bears the weight of the child and the seat assembly 2, while the backrest 12 provides auxiliary support and protection for the back of the seat assembly 2 when the child is seated.

L-Shaped Reinforcement Tube: Referring to FIGS. 2 to 4, the L-shaped reinforcement tube 3 embedded in the base 1 is a key component that enhances the seat's strength. Made of high-strength metal, such as aluminum alloy, it ensures strength while reducing overall weight. Its horizontal extension 31 extends along the support portion 11, with a precisely designed length to cover the primary stress-bearing area of the support portion 11. The vertical extension section 32 extends from the end of the horizontal extension section 31 toward the backrest 12.

Its inclination angle precisely matches that of the backrest 12, ensuring effective support for the backrest 12. In this embodiment, the L-shaped reinforcement tube 3 has a rectangular ring-shaped cross-section. This shape offers excellent bending and torsional resistance, ensuring structural stability when subjected to external forces. Of course, other cross-sections, such as circular or elliptical, are also possible.

Mounting Slots and Connecting Plates: As shown in FIGS. 2 to 4, mounting slots 4 are provided on the support portion 11 and the backrest 12, respectively, for mounting the horizontal extension section 31 and vertical extension section 32 of the L-shaped reinforcement tube 3. The shape and dimensions of the mounting slots 4 precisely match those of the corresponding sections of the L-shaped reinforcement tube 3, with a carefully calculated depth and width to ensure secure mounting of the L-shaped reinforcement tube 3 without compromising the overall structural strength of the base 1. The connecting plate 6, located behind the backrest 12, is made of high-strength sheet metal. Its shape and dimensions are designed based on the structure of the backrest 12 and its fixing requirements, and it includes through-holes that accommodate the fixing bolts.

### Connection Methods

The L-shaped reinforcement tube connects to the base: The horizontal extension section 31 and vertical extension section 32 of the L-shaped reinforcement tube 3 are tightly fitted into the mounting slots 4 of the support section 11 and backrest section 12, respectively. During installation, first accurately fit the horizontal extension section 31 into the mounting slot 4 of the support section 11, ensuring a tight fit. Then, fit the vertical extension section 32 into the mounting slot 4 of the backrest section 12, adjusting the angle. The base 1 is then secured using mechanical fasteners 5. These fasteners are preferably high-strength bolts, but other fastening methods such as screws or rivets are also acceptable. The bolts are passed from back to front through the mounting holes in the connecting plate 6 and backrest section 12, then screwed into the corresponding screw holes in the L-shaped reinforcement tube 3. Tighten them to the specified torque using a dedicated torque wrench, creating a stable three-point reinforcement structure that secures the L-shaped reinforcement tube 3 and base 1 together as a single unit.

### Operating Principle Structural

### Strength Enhancement:

During vehicle operation, the base 1 is subject to various external forces due to bumps, acceleration, deceleration, or collisions. The horizontal extension 31 of the L-shaped reinforcement tube 3 effectively resists impact forces from below the support portion 11, such as the inertial forces generated by vehicle acceleration or deceleration, and prevents the support portion 11 from bending and deformation through its own structural strength. The vertical extension 32 absorbs pressure on the backrest 12, preventing it from tilting excessively backward or breaking when the vehicle encounters rear-end collisions or bumps. The curved transition structure at the joint and the matching curved design of the mounting slot 4 ensure uniform stress distribution during load application, avoiding stress concentration at the joint. For example, in a vehicle collision, the impact force is transmitted through the L-shaped reinforcement tube 3. The curved transition structure ensures a smooth stress transition at the joint, preventing stress concentration from causing breakage of the L-shaped reinforcement tube 3 or damage to the base 1.

Multi-component collaborative working principle: Two L-shaped reinforcement tubes 3, spaced parallel and arranged along the width of the base 1, can collaboratively withstand external forces from multiple locations when subjected to load. When the vehicle is hit from the side, the two L-shaped reinforcement tubes 3 can jointly absorb and disperse the impact force, significantly improving child protection compared to a single L-shaped reinforcement tube 3. The layout design of the mounting cavity 7 and the mounting slot 4 ensures a smooth and stable installation of the seat assembly 2. Once installed in the mounting cavity 7, the weight of the seat assembly 2 is evenly distributed between the L-shaped reinforcement tubes 3 and the base 1. The top surface of the L-shaped reinforcement tube 3 is flush with or recessed from the bottom surface of the mounting cavity 7, further enhancing the load-bearing capacity and stability of the entire seat, providing a comfortable and safe riding experience for children.

It should be noted that in the description of this embodiment, the terms “front, rear,” “left, right,” “up, down,” and so on, indicating directions or positional relationships, are based on those shown in the accompanying drawings. These terms are used solely for the convenience of describing the present invention and to simplify the description. They are not intended to indicate or imply that the devices or components referred to must have, be constructed, or operate in a specific orientation. Therefore, they should not be construed as limitations on the present invention. The terms “installed,” “connected,” and “connected” should be interpreted broadly. For example, they can refer to fixed connections, detachable connections, or integral connections; they can refer to direct connections, indirect connections through an intermediary, or internal connections between two components. Those skilled in the art will understand the specific meanings of these terms in this utility model based on specific circumstances.

1. A child safety seat, comprising:
a base and
a seat assembly arranged on the base, wherein the base comprises a support portion and a backrest portion and is characterized in that: an L-shaped reinforcement tube made of metal is embedded in the base and the L-shaped reinforcement tube comprises a horizontal extension section and a vertical extension section The horizontal extension section extends along the support portion, and the vertical extension section extends from the end of the horizontal extension section to the backrest portion and its extension direction is adapted to the connection structure between the support portion and the backrest portion, so as to improve the structural strength and impact resistance of the base.

2. The child safety seat according to claim 1, characterized in that the vertical extension section is arranged to extend obliquely, and the inclination angle of the vertical extension section is adapted to the inclination angle of the backrest.

3. The child safety seat according to claim 1, characterized in that the support portion and the backrest are respectively provided with mounting grooves, the horizontal extension section of the L-shaped reinforcement tube is embedded in the mounting groove of the support portion, and the vertical extension section is embedded in the mounting groove-of the backrest.

4. The child safety seat according to claim 3, characterized in that the connection between the horizontal extension section and the vertical extension section is an arc-shaped transition structure, and the mounting groove at the connection between the support portion and the backrest is also an arc-shaped structure with a smooth transition, and the curvature radius of the arcs of the two are matched.

5. The child safety seat according to claim 1, characterized in that the L-shaped reinforcement tube is fixed to the backrest via a mechanical connector, wherein the mechanical connector is at least one selected from bolts, screws, or rivets.

6. The child safety seat according to claim 5, characterized in that a connecting plate is provided behind the backrest and the mechanical connector passes through the connecting plate and the backrest in sequence from back to front and is fixedly connected to the L-shaped reinforcement tube (3), forming a three-point reinforcement fixing structure.

7. The child safety seat according to claim 1 The child safety seat is characterized in that the cross section of the L-shaped reinforcement tube is a closed ring structure, and its cross-sectional shape includes any one of a circle, an ellipse, a rectangle or a rounded rectangle.

8. The child safety seat according to claim 1, characterized in that at least two L-shaped reinforcement tubes are provided, and each L-shaped reinforcement tube is arranged in parallel and spaced apart along the width direction of the base.

9. The child safety seat according to claim 3, characterized in that a mounting cavity with a top opening for mounting the seat assembly is formed on the support portion of the base and the mounting groove is provided at the bottom of the mounting cavity. After installation, the top surface of the L-shaped reinforcement tube is flush with or sunken into the bottom surface of the mounting cavity.
